(19) United States
(12) Patent Application Publication
(10) Pub. No.: US 2012/0313958 A1
(43) Pub. Date: Dec. 13, 2012

(54) DISPLAY DEVICE FOR AN AIR CONDITIONING SYSTEM OF A VEHICLE AND METHOD OF CONTROLLING THE SAME

(75) Inventors: Sang Shin Lee, Bucheon-si (KR); Ei Hyun Choi, Daejeon (KR)

(73) Assignees: Halla Climate Control Corp., Daejeon (KR); Hyundai Motor Company, Seoul (KR)

(21) Appl. No.: 13/236,021

(22) Filed: Sep. 19, 2011

(30) Foreign Application Priority Data
Jun. 9, 2011 (KR) 10-2011-0055445

(51) Int. Cl. G09G 5/02

(52) U.S. Cl. 345/589

(57) ABSTRACT

A display device for an air conditioning system of a vehicle may include a display unit of displaying brightness variations on a screen of the display for a predetermined time period, and a control unit of controlling the display to vary brightness on the screen of the display from a high intensity to a low intensity and vice versa while varying the length of time taken to vary the brightness. The control unit controls the display to perform a welcome function that gradually decreases the length of time when electric power may be applied to the display, and a goodbye function that gradually increases the length of time when an off button may be pushed, thereby obtaining an effect of making a dynamic impression or a static impression to meet a recent sensible trend.

### CROSS-REFERENCE TO RELATED APPLICATION

The present application claims priority to Korean Patent Application No. 10-2011-0055445 filed Jun. 9, 2011, the entire contents of which is incorporated herein for all purposes by this reference.

### BACKGROUND OF THE INVENTION

1. Field of the Invention

The present invention relates to a display device for an air conditioning system of a vehicle. More particularly, it relates to a display device applied to an air conditioning system for a vehicle which allows a control unit to vary the time taken to vary brightness from a low intensity to a high intensity and vice versa while displaying brightness variations during the time variation, thereby making a dynamic impression or a static impression of the displaying, and a control method thereof.

2. Description of Related Art

As well known, a heating, ventilating, air conditioning system (HVAC) is a device for controlling an air state of a room to a level that a vehicle rider wants by controlling an indoor temperature and humidity, and selecting and adjusting an intake air. Such an air conditioning apparatus for a vehicle, that is, an air conditioning system is installed on a center facia panel positioned ahead of a driver seat, and provided with a case 110, a plurality of switches 130 arranged at a front side of the case 110, a display 150 and an off button 170.

Such display 150 displays data on its screen in response to an adjustment of the switch 130 and displays a series of operation procedures and an operation state of the air conditioning system.

Incidentally, a conventional method of controlling the display 150 includes controlling a duty of a single color LED to realize a single color on a screen or changing same brightness intensity to a predetermined color just using a control method of a single color LED.

According to the study titled “Application Studies to Car Interior of Kansei Engineering” (Study, International Journal of Industrial Ergonomics, 19:105-114, 1997) in the name of T, Jindo & K, Hirasago, it is noted that lighting factors have received wide attention as having means for overcoming indefiniteness of sound information to designate coherent and definite data, and have been studied as having enhanced a brand value of a vehicle and the feeling of satisfaction in sensibility over the usability.

According to such conventional methods, however, there has been a limit that when a vehicle is started-up and electric power is accordingly applied to a display apparatus or the off button 170 of an air conditioning system is pushed, particularly, at night, the display 150 of the air conditioning system for a vehicle displays data with an always same color lighting or a limited color, and is changed or turned on/off just in an always same lighting color or a limited color, thereby lowering a rider satisfaction from a vehicle and making a vehicle rider reconsider its marketability.

Also, when driving at night, since a driver drives a vehicle whilst turning off all of the interior lights other than the headlights to look far ahead, other riders except for the driver feel the boredom of the long driving under such the dark interior environment of the vehicle and accordingly there has been a problem that it is difficult to satisfy a user's desire in sensibility with such a conventional method.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a display device applied to an air conditioning system for a vehicle which is provided therein with a welcome or goodbye function to meet a recent emotional trend capable of releasing a user's boredom by complexly changing brightness intensities and control cycles on a screen of a display when starting up and applying electric power to a display device under a dark interior environment of a vehicle, or when pushing an off button of the air conditioning system.

In one aspect of the present invention, a display device for an air conditioning system of a vehicle may include a control unit of controlling brightness variations from a low intensity to a high intensity while varying the time (one cycle time) taken to vary the brightness in one cycle; and a display of displaying each of the brightness variations on a screen of the display during the time period.

Also, it is characterized by that when electric power is applied to the display device, the control unit controls the display unit to perform a welcome function of gradually decreasing each of cycle time periods in brightness intensity during the time period.

Particularly, it is preferable that the control unit controls the display to change a display color of the display to an already stored color (hereinafter, predetermined color) in response to an indoor temperature of a vehicle after performing the welcome function.

Particularly, it is characterized by that the indoor temperature of a vehicle is a discharge temperature or a set up temperature having been set up before the air conditioning system is turned off.

Also, it is characterized by that, when the off button of the air conditioning system is pushed, the control unit controls the display to perform a goodbye function of gradually increasing each of cycle time periods in brightness intensity during the time period.

Particularly, it is characterized by that, after performing the goodbye function, the control unit allows the display to change a displayed color of the display to a predetermined color in response to an outdoor temperature of a vehicle.

Also, it is preferable that the control unit controls the display to perform each of the welcome function and the goodbye function within 3 seconds, respectively.

In another aspect, the present invention provides a method of controlling a display device for an air conditioning system of a vehicle including the steps of varying brightness from a high intensity to a low intensity and vice versa while varying the time (one cycle time) taken to vary the brightness by means of a control unit, and displaying each of the brightness variations during the time period by means of a display.

Also, it is preferable that when electric power is applied to the display device, the method includes performing a welcome function of gradually decreasing the cycle time period in brightness intensity during the predetermined time period by means of the control unit.

Particularly, it is characterized by that the method further includes changing a display color of the display to a predetermined color in response to a discharge temperature or a set up temperature having been set up before the air conditioning system is turned off, after performing the welcome function.

Also, it is characterized by that, when an off button of the air conditioning system is pushed, the method includes controlling the display to perform a goodbye function of gradually increasing the cycle time period in brightness intensity during the predetermined time period by means of the control unit.

Particularly, it is preferable that, after performing the goodbye function, the method includes controlling the display to change a displayed color on a screen of the display to a predetermined color in response to an outdoor temperature of a vehicle by means of the control unit.

Also, it is preferable that the method includes controlling the display to perform each of the welcome function and the goodbye function within 3 seconds, respectively, by means of the control unit.

In the display device for an air conditioning system of a vehicle and the method of controlling the display device according to the present invention, when a user starts up a vehicle to apply electric power to the display device of the air conditioning system, the brightness intensities on the display rhythmically vary together with the cycle time period during the predetermined time period taken to vary the brightness through the welcome function, thereby enabling to obtain the effect of transferring a message saying that the air conditioning system starts to operate even though a driver averts his eyes from the display scene during driving a vehicle. In addition, since the display is not simply controlled but complexly controlled in combination of the brightness intensities and the time taken to vary the brightness intensities, a user feels a dynamic impression of the displaying.

Meanwhile, in the display device for an air conditioning system of a vehicle and the method of controlling the display device according to the present invention, when a user pushes the off button, the brightness intensities on the display smoothly vary together with the cycle time period during a cycle time period taken to vary the brightness through the goodbye function, thereby enabling to obtain the effect of transferring a message saying that the air conditioning system stops to operate even though a driver averts his eyes from the display scene during driving a vehicle. In addition, since the display is not simply controlled but complexly controlled in combination of the brightness intensities and the time taken to vary the brightness intensities, a user feels a static impression of the displaying.

Also, according to the present invention, the display device for an air conditioning system of a vehicle is provided with the welcome function or goodbye function to meet the recent emotional trend, thereby satisfying vehicle riders with the vehicle, and making the riders reconsider the brand image.

It is understood that the term “vehicle” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view showing a display device for an air conditioning system of a vehicle according to a conventional art.

FIG. 2a is a graph illustrating a welcome function according to an embodiment of the present invention.

FIG. 2b is a graph illustrating a welcome function according to another embodiment of the present invention.

FIG. 2c is a view showing the brightness variations on the display with the time period when the welcome function is applied to the display according to the embodiment of the present invention.

FIG. 3a is a graph illustrating a goodbye function according to an embodiment of the present invention.

FIG. 3b is a graph illustrating a goodbye function according to another embodiment of the present invention.

FIG. 3c is a view showing the brightness variations on the display with the time period when the goodbye function is applied to the display according to the embodiment of the present invention.

FIG. 4 is a view illustrating states of the display when the welcome function and the goodbye function are consecutively performed according to the embodiment of the present invention.

FIG. 5 is a flow chart illustrating the procedure of the welcome function and the goodbye function when the welcome function and the goodbye function are consecutively performed according to the embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

According to an exemplary embodiment of the present invention, the display device for an air conditioning system of a vehicle periodically varies in brightness on a screen of a display of the display device from a high intensity to a low intensity and vice versa, performs a welcome function and a goodbye function in which a variable cycle time period, that is, a varying period is applied, and varies in colors on the screen of the display in response to an indoor temperature or outdoor temperature of a vehicle after the functions are performed.

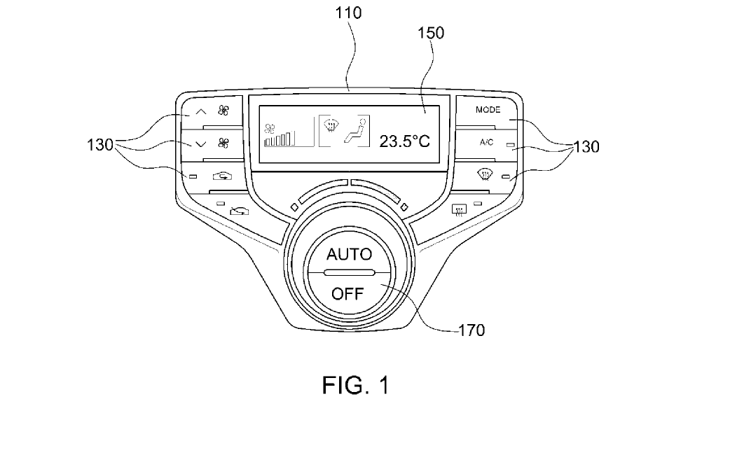

FIG. 1 is shows a display device applied to an air conditioning system for a vehicle according to a conventional art. The display device is mounted on a center facia panel ahead of a driver's seat and provided with a case 110, a plurality of switches 130 installed at the front side of the case 110, a display 150 and an off button 170.

The display 150 of the conventional display device for an air conditioning system of a vehicle does not vary in brightness when turned-off or turned-on, but just displays data in a single color at the turned-on state of the display. Further, as disclosed in Korean Utility Model Registration No. 20-415590, a conventional display 150 and a button each just glow with 3-color LEDs for a backlight which are provided therein and controlled by a pulse width modulation method in response to a selected indoor temperature of a vehicle.

In contrast, the display device according to an exemplary embodiment of the present invention, which is applied to an air conditioning system for a vehicle, is provided therein with a control unit controlling the display to perform a welcome function before the above method is applied thereto or a goodbye function after the above method is applied thereto and a display 150 displaying the resultants.

The control unit performs a control function by which brightness on a display is changed from a high intensity to a low intensity and vice versa and at the same time by which the period taken to vary the brightness from a high intensity to a low intensity and vice versa is changed. The control unit controls the display so that the brightness on the display may be changed from a low intensity to a high intensity and again from a high intensity to a low intensity. On the contrary to this, the control unit controls the display so that the brightness on the display may be changed from a high intensity to a low intensity and again from a low intensity to a high intensity. Also, the control unit may control the display so that the brightness variation may be displayed several times during one cycle taken to vary the brightness one time from a high intensity to a low intensity and vice versa as mentioned above. That is, the control unit may control the brightness variation in various types according to a predetermined program.

At the same time, the control unit may control the display so that the time (the length of time in one cycle) taken to vary the brightness from a high intensity to a low intensity and vice versa may be changed. The control unit, when electric power is applied to the display device for an air conditioning system of a vehicle, may control the display to perform a welcome function by which the period taken to vary the brightness intensity from high to low and vice versa may gradually decrease. Also, the control unit, when a vehicle rider pushes an off button of an air conditioning system, may control the display to perform a goodbye function by which the period taken to vary the brightness intensity from high to low and vice versa may gradually increase. At this time, the control unit may control the display so that the total time taken to finish the brightness variation may be limited to 3 seconds. Also, the control unit may control the display to consecutively display colors, letters, symbols, or figures, etc. on a screen of the display while performing the welcome function or the goodbye function.

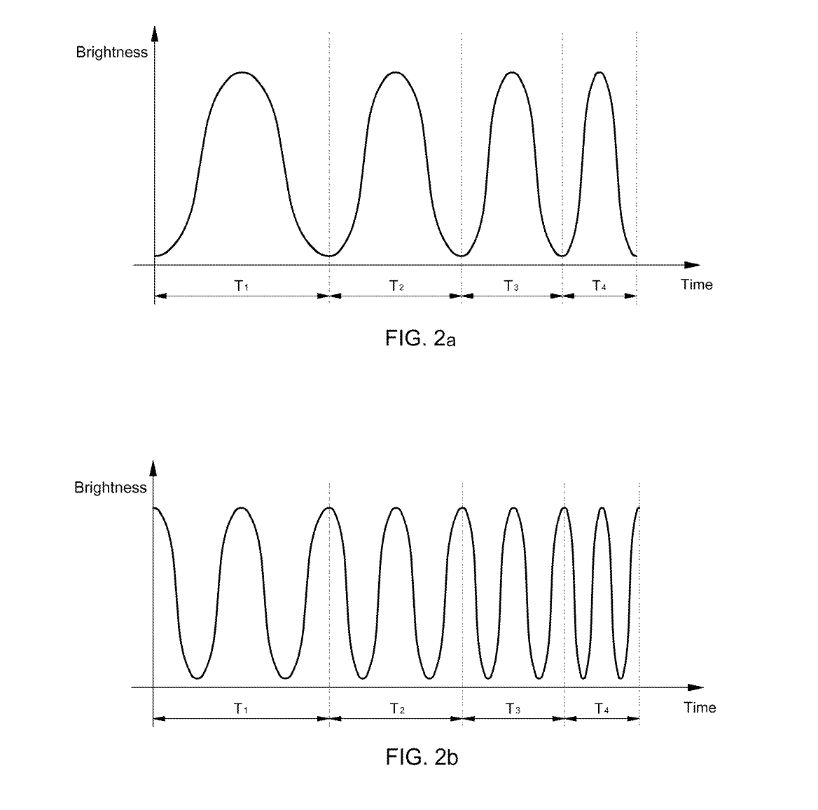

FIG. 2a and FIG. 2b illustrate welcome functions according to an exemplary embodiment of the present invention.

As shown in FIG. 2a, the control unit, when electric power is applied to the display device for an air conditioning system of a vehicle, controls the display to vary the brightness on the display from a low intensity to a high intensity and again from a high intensity to a low intensity. On the contrary to this, as shown in FIG. 2b, the control unit may also control the display to vary the brightness on the display from a high intensity to a low intensity and again from a low intensity to a high intensity, so that the high to low brightness variation may be performed two times in one period.

The cycle time periods T1, T2, T3 and T4 shown in FIG. 2a and FIG. 2b mean the time (length of time in one cycle) taken to perform one time or two times the brightness variation on the display from a low brightness intensity to a high brightness intensity and vice versa, during the cycle time period. The control unit may control the variation in brightness intensity and at the same time control the cycle time periods T1, T2, T3 and T4 so that the length of times may gradually decrease in the order of T1 to T4 when performing a welcome function. At this time, the control unit may control the display device so that the total time (predetermined time period) of summing up the cycle time periods T1, T2, T3 and T4 may be limited to 3 seconds.

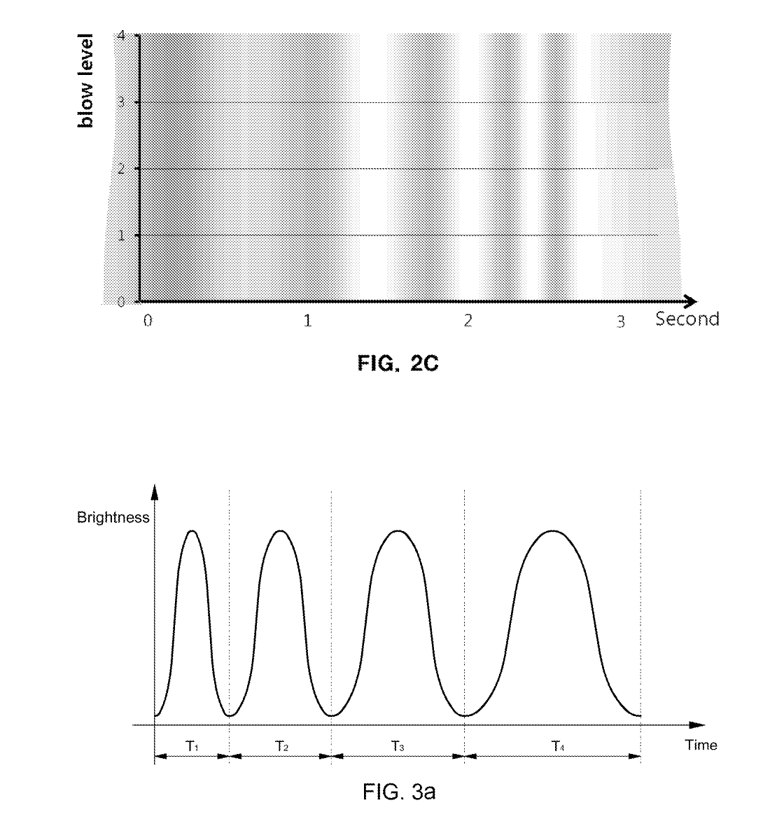

FIG. 3a and FIG. 3b illustrate a goodbye function according to another exemplary embodiment of the invention.

When a vehicle rider pushes the off button 170 of an air conditioning system, the control unit, as shown in FIG. 3a, controls the display to vary brightness on the display from a low intensity to a high intensity and again from a low intensity to a high intensity. On the contrary to this, as shown in FIG. 3b, the control unit controls the display to vary the brightness from a high intensity to a low intensity and again from a low intensity to a high intensity, so that the high to low brightness intensity variation may be performed two times in one cycle of time.

The cycle time periods T1, T2, T3 and T4 shown in FIG. 3a and FIG. 3b mean the time taken to perform one time or two times the brightness variation on the display from a low brightness intensity to a high brightness intensity and vice versa, during one cycle of time. The control unit may control the variation in brightness intensity and at the same time control the cycle time periods T1, T2, T3 and T4 so that the length of time, that is, each cycle time period may gradually increase in the order of T1 to T4 when performing a goodbye function. At this time, the control unit may control the display device so that the total time of summing up T1, T2, T3 and T4 may be limited to 3 seconds.

Particularly, in case where a vehicle driver manipulates an air conditioning system during driving, the driver cannot concentrate attention upon the display expect before and after driving a vehicle having an air conditioning system, thereby it is difficult to accurately perceive a change in the display during driving. However, only an assistant can carefully watch the display device during driving. Accordingly, the display 150, which will be described below, displays brightness variation and its cycle time period variation on a screen of the display so that vehicle riders can easily see the variations even during driving. At this time, however, if the total time of performing the goodbye function excessively becomes longer, there may be a safety problem rather than the effect of transferring a message saying that the operation of an air conditioning system is finished even though a driver does not concentrate attention upon the display during driving. Accordingly, the control unit according to the present invention has been designed to effectively control the functions, particularly, the goodbye function, so that the effect of the present invention may become maximum.

The display 150 displays each of the brightness variations during the predetermined time period. The display 150 may display in real time the brightness and the cycle time period that are simultaneously controlled by the control unit. As described above, the control unit controls the brightness variations in various types according to an originally programmed data and accordingly the display 150 displays the results. Also, the display 150 displays on a screen of the display the variations resulting from the welcome function and goodbye function, and, at the same time, displays colors, letters, symbols, or figures, which can consecutively be changed by the control unit.

The display device for an air conditioning system of a vehicle may further include a storage unit for storing the welcome function or the goodbye function in various types. The mode switch out of the plurality of switches 130 is used to select one of the welcome functions which have been stored in various types in the storage unit.

According to an exemplary embodiment of the present invention, the storage unit may store the welcome functions as shown in FIG. 2a and FIG. 2b, and a user may use the mode switch among the plurality of switches 130 when selecting any one of the functions. At the time of selecting any one of the functions, when electric power is applied to the display device for an air conditioning system of a vehicle, the control unit controls the display to perform the selected welcome function. Also, the storage unit stores the goodbye functions as shown in FIG. 3a and FIG. 3b, and a user may use the mode switch among the plurality of switches when selecting any one of the functions. After selecting any one of the functions, when a user pushes the off button 170, the control unit controls the display to perform the goodbye function.

After the function is performed, the control unit controls the display 150 of the display device for an air conditioning system so that the display 150 may display variable pictures with a color having been stored in the storage unit in response to a temperature.

In case where the control unit controls the display to display brightness variations with colors having been stored in response to an indoor temperature after the welcome function is performed, the indoor temperature of a vehicle may be a discharge temperature or a set up temperature having been set up before the air conditioning system is turned off.

FIG. 2c is a view showing the brightness intensities displayed on a screen of the display at each point of time when the welcome function is applied to the display according to the exemplary embodiment of the present invention. It is preferable that the control unit controls the display to finish the welcome function within 3 seconds. The control unit may control the display 150 to display a yellow picture as a color having been stored in advance in response to a discharge temperature (42° C.) or a set up temperature (24° C.) having been set up before the air conditioning system is turned off. At this time, the deeper the displayed color is, it means that the stronger the winds from the air conditioning system have been set up to blow, and the lighter the displayed color is, it means that the weaker the winds from the air conditioning system have been set up to blow.

In this manner, since the control unit performs not a simple control but a complex control by which the brightness intensity and the length of time (cycle time period) taken to vary the brightness can vary simultaneously, vehicle riders feel a dynamic impression when electric power is applied to the display device.

Meanwhile, after performing the goodbye function, the control unit may control the display 150 to display data with colors having been stored in advance in response to an outdoor temperature of a vehicle.

FIG. 3c is a view showing the brightness variation on the display together with the cycle time period variation during the predetermined time period when the goodbye function is applied to the display according to the exemplary embodiment of the present invention. The control unit may control the display so that the goodbye function may be performed within 3 seconds, and then, may control the display 150 to display data with yellow as a color having been stored at a temperature of 25° C. that corresponds to an outdoor temperature of a vehicle when pushing the off button 170 of the air conditioning system. As the weather becomes hot, if the outdoor temperature of a vehicle increases to a temperature of 35° C., the control unit may control the display 150 to display data with the gradually varying color according to the temperature variation.

In this manner, since the control unit performs not a simple control but a complex control by which the brightness intensity and the length of time taken to vary the brightness can vary simultaneously, vehicle riders may feel a static impression when pushing the off button 170 of the air conditioning system.

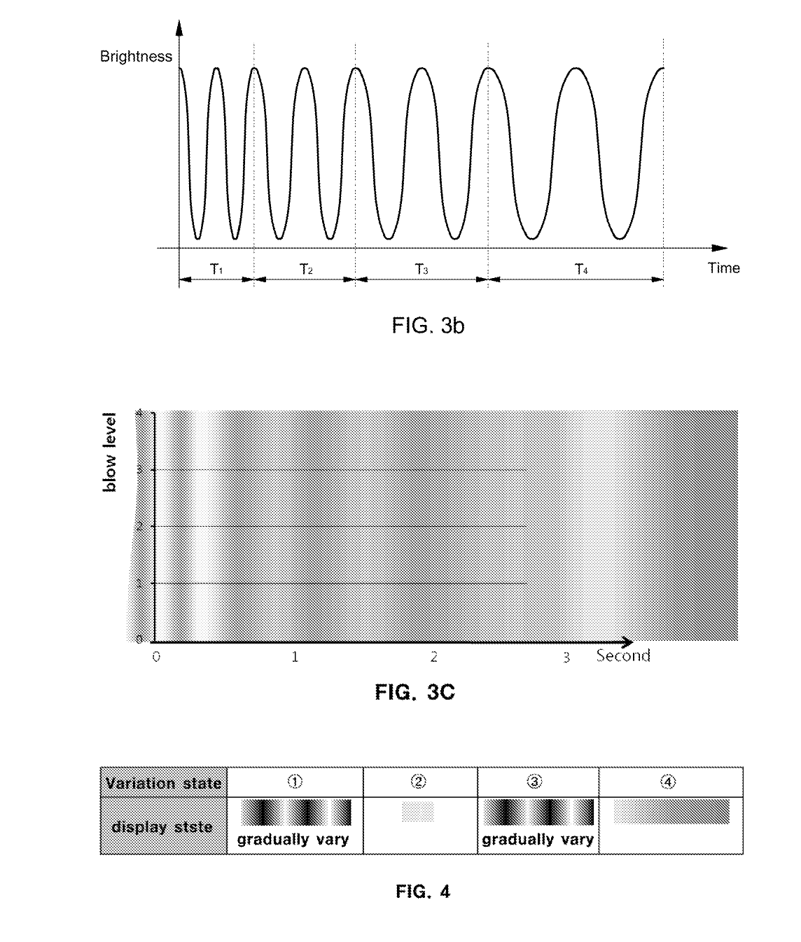

FIG. 4 is a view illustrating states of the display when the welcome function and the goodbye function are consecutively performed according to the other exemplary embodiment of the present invention, which illustrates the variation states displayed, according to a user's manipulation, on the display 150 of the display device applied to an air conditioning system.

The first state indicates an operation of the welcome function by which the brightness on a screen of the display varies from a high intensity to a low intensity and vice versa and at the same time the cycle time period taken to vary the brightness from a high intensity to a low intensity and vice versa gradually decreases when a vehicle driver starts up a vehicle and electric power is accordingly applied to the display device.

The second state indicates that the display 150 displays a picture with yellow corresponding to a discharge temperature of 42° C. or a temperature of 24° C. having been set up before the air conditioning system is turned off, after the welcome function is finished.

The third state indicates an operation of the goodbye function by which the brightness varies from a high intensity to a low intensity and vice versa and at the same time the cycle time period taken to vary the brightness gradually increases when a vehicle driver pushes the off button 170 during driving.

The fourth state indicates a state of the display after the goodbye function is finished, that is, the fourth state indicates an operation state of the display displaying a picture with yellow corresponding to an outdoor temperature of 25° C. at the time of pushing the off button 170. Thereafter, as the weather becomes hot, if the outdoor temperature of a vehicle gradually increases to a temperature of 35° C., it also indicates that the display displays a picture with colors corresponding to each temperature during the temperature variation.

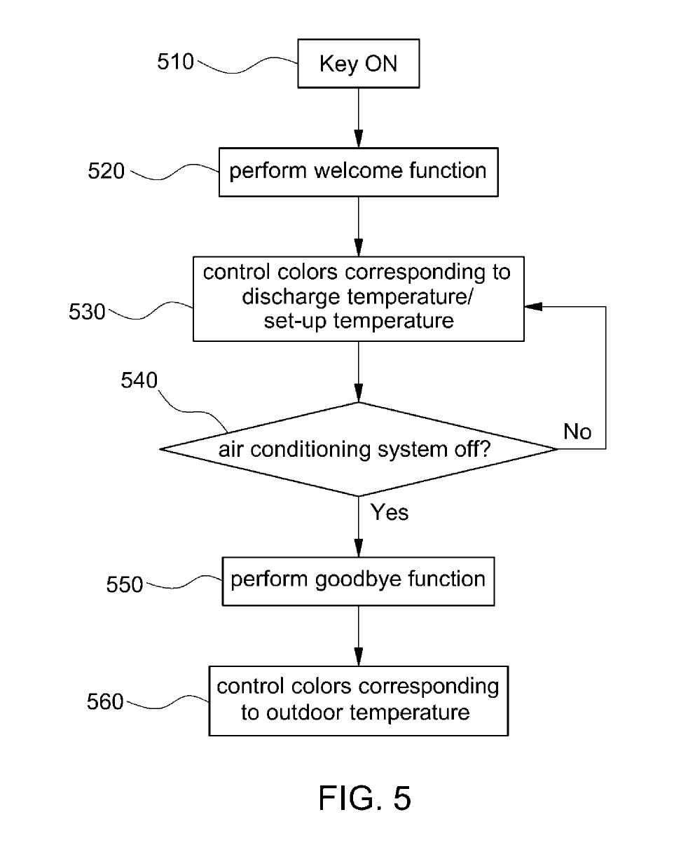

FIG. 5 is a flow chart illustrating the procedure of the welcome function and the goodbye function when the welcome function and the goodbye function are consecutively performed according to the exemplary embodiment of the present invention.

First, when a vehicle driver starts up an engine (Key on), electric power is supplied to the display device thereby enabling to perform the welcome function (step 510). While the welcome function is performed, brightness on the display varies from a high intensity to a low intensity and vice versa, and at the same time, the cycle time period taken to vary the brightness gradually decreases (step 520). The welcome function is controlled by the control unit. After the welcome function is finished, colors displayed on a screen of the display are controlled by the control unit in response to the discharge temperature or the set up temperature having been set up before the air conditioning system is turned off (step 530). While the control unit monitors an operation of the air conditioning system, if a user manipulates the set up temperature as described above in a state the air conditioning system is turned on, or if the discharge temperature is changed by controlling the air conditioning system, the colors on the display are periodically changed to colors having been stored in advance in response to the changed temperature (step 540). At this time, if the air conditioning system is turned off, that is, if a vehicle rider pushes the off button 170 of the air conditioning system, the goodbye function is performed immediately (step 550). While the goodbye function is performed, the brightness on the display is changed from a high intensity to a low intensity and vice versa, and at the same time, the cycle time period taken to change the brightness from a high intensity to a low intensity and vice versa gradually increases. After the goodbye function is finished, color is controlled by the control unit so that the color may be changed in response to an outdoor temperature of a vehicle (step 560).

According to the air conditioning system to which the welcome function or the goodbye function is applied and the method of controlling the air conditioning system, vehicle riders feel a dynamic impression from the display and get an enhanced satisfaction with the vehicle, thereby further resulting in the effect of making the riders reconsider a brand image.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A display device for an air conditioning system of a vehicle, comprising:
a display unit of displaying brightness variations on a screen of the display unit for a predetermined time period; and
a control unit of controlling the display unit to vary brightness on the screen of the display unit from a high intensity to a low intensity or vice versa in one cycle time while varying a cycle time period taken to vary the brightness during the predetermined time period.

2. The device of claim 1, wherein the control unit controls the display unit to perform a welcome function that gradually decreases the cycle time period during the predetermined time period when electric power is applied to the display unit.

3. The device of claim 2, wherein the control unit controls the display unit to change colors on the screen of the display unit to colors having been predetermined in response to an indoor temperature of the vehicle after the welcome function is finished.

4. The device of claim 3, wherein the control unit controls the display unit to perform welcome function within 3 seconds.

5. The device of claim 3, wherein the indoor temperature is a discharge temperature or a temperature having been set up before the air conditioning system is turned off.

6. The device of claim 5, wherein the control unit controls the display unit to perform welcome function within 3 seconds.

7. The device of claim 1, wherein the control unit controls the display unit to perform a goodbye function that gradually increases the cycle time period during the predetermined time period when an off button is pushed.

8. The device of claim 7, wherein the control unit controls the display unit to perform the goodbye function within 3 seconds.

9. The device of claim 7, wherein the control unit controls the display unit to change colors on the screen of the display unit to colors having been predetermined in response to an outdoor temperature of the vehicle after the goodbye function is finished.

10. The device of claim 9, wherein the control unit controls the display unit to perform the goodbye function within 3 seconds.

11. A method of controlling a display device for an air conditioning system of a vehicle, comprising the steps of:
controlling through a control unit brightness variations from a high intensity to a low intensity or vice versa in one cycle time while varying a cycle time period taken to vary brightness in a predetermined time period; and
displaying through a display each of the brightness variations during the predetermined time period.

12. The method of claim 11, wherein the control unit controls the display to perform a welcome function that gradually decreases the cycle time period during the predetermined time period when electric power is applied to the display.

13. The method of claim 12, wherein the control unit controls the display to perform the welcome function within 3 seconds.

14. The method of claim 12, further comprising the step of controlling through the control unit the display to change colors on a screen of the display to colors having been predetermined in response to an indoor temperature of the vehicle after the welcome function is finished.

15. The method of claim 14, wherein the control unit controls the display to perform the welcome function within 3 seconds.

16. The method of claim 14, wherein the control unit controls the display to perform a goodbye function that gradually increases the cycle time period during the predetermined time period when an off button is pushed.

17. The method of claim 16, wherein the control unit controls the display to perform the goodbye function within 3 seconds.

18. The method of claim 14, wherein the control unit controls the display to change colors on the screen of the display to colors having been predetermined in response to an outdoor temperature of the vehicle after the goodbye function is finished.

19. The method of claim 18, wherein the control unit controls the display to perform the goodbye function within 3 seconds.
